(19) United States
(12) Patent Application Publication
(10) Pub. No.: US 2013/0261818 A1
(43) Pub. Date: Oct. 3, 2013

(54) INTEGRATED ELECTRIC POWER GENERATION AND STEAM DEMAND CONTROL SYSTEM FOR A POST COMBUSTION CO2 CAPTURE PLANTS

(71) Applicants: Mark T. Monical, Houston, TX (US); Nareshkumar B. Handagama, Knoxville, TN (US)

(72) Inventors: Mark T. Monical, Houston, TX (US); Nareshkumar B. Handagama, Knoxville, TN (US)

(73) Assignee: ALSTOM TECHNOLOGY LTD, Baden (CH)

(21) Appl. No.: 13/561,126

(22) Filed: Jul. 30, 2012

Related U.S. Application Data
(60) Provisional application No. 61/617,711, filed on Mar. 30, 2012.

(51) Int. Cl. G05F 5/00

(52) U.S. Cl. 700/287

(57) ABSTRACT

A power plant includes an electric power generation plant in communication with a CO₂ capture system. The control system includes a first processor and a data storage device. The power plant includes a computer having a second processor that is configured to generate and transmit economic information relating to real time electric power pricing and/or CO₂ capture, compression and emissions credits. The first processor is configured to receive the economic information relating to real time electric power pricing and/or CO₂ capture, compression and emissions credits. The first processor is also configured to execute software operable to control the electric power generation plant and the CO₂ capture system based on the economic information relating to real time electric power pricing and/or CO₂ capture, compression and emissions credits to optimize the economics of the sale of the electric power and/or CO₂ capture, compression and emissions credits.

### CROSS-REFERENCE TO RELATED APPLICATION

The present application claims the benefit under 35 U.S.C. §119 (e) of the Provisional Patent Application Ser. No. 61/617,711 filed Mar. 30, 2012, the disclosure of which is incorporated herein by reference in its entirety.

### FIELD

The present disclosure is generally directed to an integrated electric power generation and steam demand control system for a post combustion carbon dioxide (CO₂) capture plant, and more particularly a control system which controls electric power generation, steam flow and the CO₂ capture plant based on the economics of the sale of power and/or the economics of CO₂ capture, compression and emissions credits.

### BACKGROUND

Some fossil fuel power plants combust carbon based fuels such as coal, natural gas and oil for the production of steam which in turn is employed in the production of electricity. Flue gas is a byproduct of the combustion of the carbon based fuels. The flue gas may contain contaminants, including, but not limited to particulates, nitrogen oxides (NOₓ), mercury, CO₂, and the like.

Generation of greenhouse gases can lead to global warming. Since CO₂ is identified as a greenhouse gas, carbon capture and storage (CCS) is considered to be one potential way to reduce the release of greenhouse gases into the atmosphere and to control global warming CCS can include the process of CO₂ capture, compression, transport and storage. Capture of CO₂ can include processes in which CO₂ is removed from the flue gas after combustion of the carbon based fuel or the removal and processing of carbon before combustion. Capture of CO₂ from flue gas can include use of absorbents and adsorbents. The absorbents and adsorbents are regenerated so that they may be reused. The capture of CO₂ requires the input of relatively large amounts of energy. For example, the regeneration of the absorbents and adsorbents typically requires a significant amount of steam.

Energy costs such as, for example, the price of electric power, can vary depending upon demand. For example, the price of electric power during periods of high demand can be ten times or more than the cost of power at low demand periods. In addition, the price of electric power can drop to zero or become negative for short periods of time when the electric power grid is over supplied with power, such as when a large number of wind generators come on line.

CO₂ prices can be affected by the ability of power plants to meet regulatory mandates for CO₂ capture. A power plant may have total CO₂ emissions limits set on an annual basis, for example as a percentage of a design value. CO₂ emissions above the limits are typically offset by CO₂ emissions credits attributed to CO₂ emissions of another plant that are below the limit. CO₂ emissions credits can be bought and sold in the market place, for example by long term contracts.

Profit or net revenue of a power plant can be calculated as the sum of the power revenue plus CO₂ capture revenue less the sum of fuel costs, auxiliary power costs, the cost of CO₂ credits, a margin on power revenue and fixed costs.

### SUMMARY

According to aspects disclosed herein, there is provided a power plant including an electric power generation plant in communication with a CO₂ capture system. The control system includes a first processor and a data storage device. The power plant includes a computer having a second processor that is configured to generate and transmit economic information relating to real time electric power pricing and/or CO₂ capture, compression and emissions credits. The first processor is configured to receive the economic information relating to real time electric power pricing and/or CO₂ capture, compression and emissions credits. The first processor is configured to execute software operable to control the electric power generation plant and the CO₂ capture system based on the economic information relating to real time electric power pricing and/or CO₂ capture, compression and emissions credits. to optimize the economics of the sale of the electric power and/or CO₂ capture, compression and emissions credits.

There is also disclosed herein a method of operating a power plant. The method includes providing an electric power generation plant in communication with a CO₂ capture system; providing a control system in communication with the electric power generation plant and the CO₂ capture system, the control system including a first processor and a data storage device; and providing a computer having a second processor. The method further includes generating in the second processor economic information relating to real time electric power pricing and/or CO₂ capture, compression and emissions credits. The method includes a step of receiving in the first processor the economic information relating to real time electric power pricing and/or CO₂ capture, compression and emissions credits. The first processor controls the electric power generation plant and the CO₂ capture system based on the economic information relating to real time electric power pricing and/or CO₂ capture, compression and emissions credits to optimize the economics of the sale of the electric power and/or the economics of CO₂ capture, compression and emissions credits.

### BRIEF DESCRIPTION OF FIGURES

With reference now to the figures where all like parts are numbered alike;

FIG. 1 is a schematic diagram of a power plant and CO₂ capture system disclosed herein; and

FIG. 2 is graph of CO₂ capture turn down versus electricity price;

FIG. 3 is schematic of the architecture for a control system configured to affect Model Predictive Control (MPC) for real time optimization of the power plant and the CO₂ capture system;

FIG. 4 is a schematic diagram of a control system for regulatory control of a power plant and the CO₂ capture system; and

FIG. 5 includes a schematic diagram of a portion of a CO₂ capture system.

### DETAILED DESCRIPTION

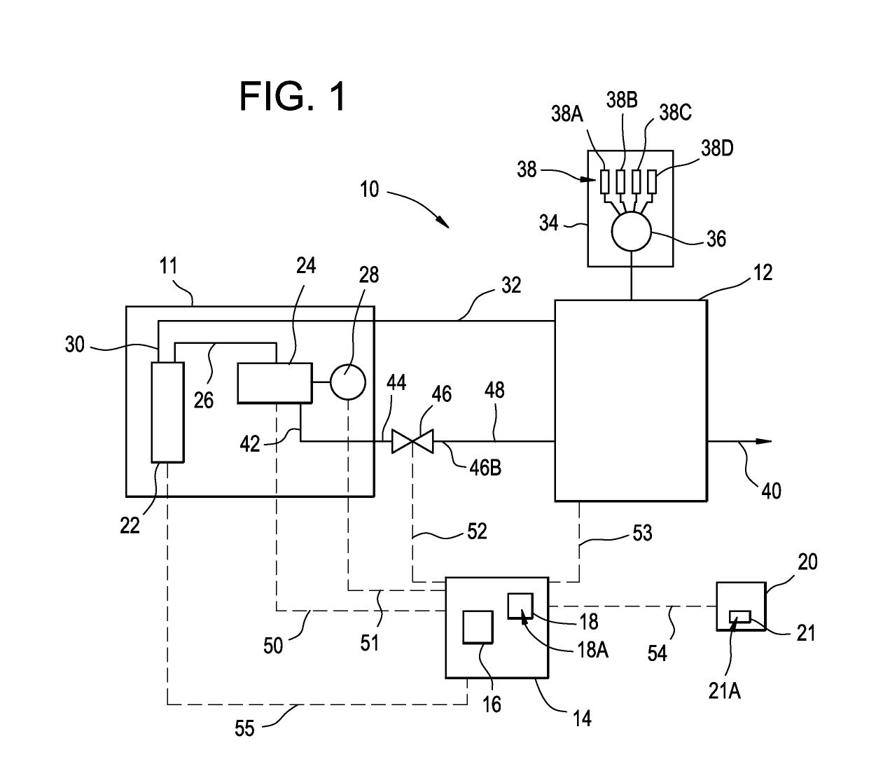

As illustrated in FIG. 1, a power plant 10 includes an electric power generation plant 11 in communication with a CO₂ capture system 12, such as but not limited to an Advanced Amine Process (AAP). A control system 14 is in communication with the electric power generation plant 11 and the CO₂ capture system 12. The control system 14 includes a first processor 16 and a data storage device 18. The control system 14 is in communication with a computer 20 that includes a second processor 21 which is configured to generate and transmit economic information 21A relating to real time electric power pricing and the economics of CO₂ capture, compression and emissions credits. The first processor 16 is configured to receive the economic information relating to real time electric power pricing and the economics of CO₂ capture, compression and emissions credits from the second processor 21. The first processor 16 is also configured to execute software 18A, for example, stored in the memory 18, operable to control the electric power generation plant 11 and the CO₂ capture system 12, based on an algorithm operable to optimize the economics of the sale of the electric power and/or the economics of CO₂ capture, compression and emissions credits.

A shown in FIG. 1 the electric power generation plant 11 includes a boiler 22 in communication with a steam turbine system 24 via a steam supply line 26. The boiler 22 is boiler configured to be fired with coal, natural gas and/or like fuel. An electric generator 28 is coupled to the steam turbine system 24. The boiler 22 defines an outlet 30 for discharging flue gas resulting from combustion of a fuel, such as coal, in the boiler. The flue gas is conveyed to the CO₂ capture system 12 via a conduit 32 for removal of CO₂ from the flue gas. The CO₂ capture system 12 is in communication with a processing system 34 for compressing and storing the CO₂ removed from the flue gas. The processing system 34 includes a compressor 36 and a plurality of storage vessels 38, for example, vessels 38A-38D shown, in communication with the compressor 36 for storing compressed CO₂ therein. The CO₂ capture system 12 includes a discharge port 40 for discharging treated flue gas therefrom.

As illustrated in FIG. 1, the steam turbine system 24 includes a branch connection 42 for discharging steam, such as low pressure steam, therefrom. The branch connection 42 has a steam line 44 connected thereto. The steam line 44 line has a valve 46 positioned therein. The valve 46 has an outlet 46B that is in communication with the CO₂ capture system 12 via a steam line 48, for conveying steam to the CO₂ capture system 12 for use in regenerating fluids used to remove the CO₂ from the flue gas. The amount of CO₂ (e.g., tons per hour) removed from the flue gas by the CO₂ capture system 12 increases with increasing amounts of steam supplied thereto.

Still referring to FIG. 1, the control system 14 is in communication with the steam turbine system 24, the electric generator 28, the valve 46, the CO₂ capture system 12 and the computer 20 via signal lines 50, 51, 52, 53 and 54, respectively. The control system 14 is also in communication with the boiler 22 vial signal line 55.

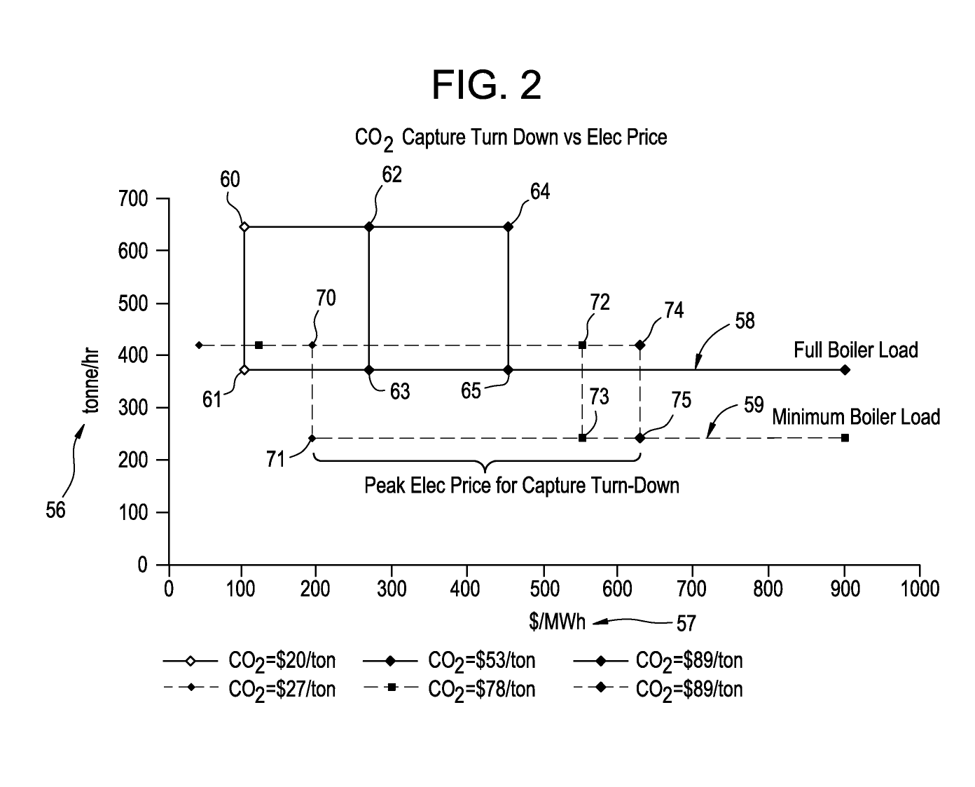

In one embodiment, the first processor 16 is configured to execute the software 18A to determine when the price of CO₂ is sufficiently high to justify operation of the CO₂ capture system 12 and/or when the price of electric power is sufficiently higher that the price of CO₂ to justify reducing the rate of CO₂ capture. FIG. 2 illustrates a graph of reduction in the rate of CO2 capture (i.e., CO₂ capture turn down) on the Y axis 56 in tons per hour and the price electric power on the X axis 57 in dollars ($) per MHh. In one embodiment, the processor 16 is configured to execute software 18A operable to control the amount of steam supplied to the CO₂ capture system 12 depending on operating load of the boiler 22, the CO₂ pricing and/or electricity pricing. For example, with reference to FIG. 2, during full load operation 58 of the boiler 22, the processor 16 reduces the rate of CO₂ capture from about 650 tons per hour to about 375 tons per hour by throttling closed the valve 46 to reduce steam flow to the CO₂ capture system 12, if it is economical to do so. The processor 16 executes an algorithm (e.g., encoded within software 18A) operable to calculate whether it is economical to reduce the rate of CO₂ capture by analyzing load of the boiler 20 and economic information relating to real time electric power pricing and the economics of CO₂ capture, compression and emissions credits, transmitted thereto from the computer 20. For example, during full load operation 58 of the boiler 22, the processor 16 reduces the rate of CO₂ capture from about 650 tons per hour to about 375 tons per hour: 1) if the market price of CO₂ is $20 per ton and the electric power price is about $100 per MWh or greater (from point 60 to point 61 on FIG. 2); 2) if the market price of CO₂ is $53 per ton and the electric power price is about $275 per MWh or greater (from point 62 to point 63 on FIGS. 2); and 3) if the market price of CO₂ is $89 per ton and the electric power price is about $450 per MWh or greater (from point 64 to point 65 on FIG. 2).

During minimum load operation 59 of the boiler 22, the processor 16 reduces the rate of CO₂ capture from about 425 tons per hour to about 250 tons per hour by throttling closed the valve 46 to reduce steam flow to the CO₂ capture system 12, if it is economical to do so. For example, the processor 16 will reduce the rate of CO₂ capture from about 425 tons per hour to about 250 tons per hour: 1) if the market price of CO₂ is $27 per ton and the electric power price is about $195 per MWh or greater (from point 70 to point 71 on FIG. 2); 2) if the market price of CO₂ is $78 per ton and the electric power price is about $550 per MWh or greater (from point 72 to point 73 on FIGS. 2); and 3) if the market price of CO₂ is $89 per ton and the electric power price is about $640 per MWh or greater (from point 74 to point 75 on FIG. 2). In addition, the processor 16 transmits signals to the steam turbine system 24 via the signal line 50 and to the electric generator 28 via the signal line 51 to increase electric power production during the period of time when the rate of CO₂ capture in the CO₂ capture system 12 is reduced, to increase the profit from the sale of electric power and/or CO₂. The throttling closed of the valve 46 decreases steam flow to the CO₂ capture system 12 and allows the steam to be used in the steam turbine 24 for the increased electric power production by the electric generator 28.

While the rate of CO₂ capture during full load operation 58 of the boiler 22 is described as being from about 650 tons per hour to about 375 tons per hour and from about 425 tons per hour to about 250 tons per hour for minimum load operation 59 of the boiler, the present disclosure is not limited in this regard as reductions in the rate of CO₂ capture of other magnitudes may be employed without departing from the broader aspects disclosed herein. In addition, the rates of reduction of CO₂ capture may be initiated at CO₂ prices other than $20, $27, $53, $78 and $89 per ton and electric power prices other than $100, $195, $275, $450, $550 and $640 per MWh. Although processor 16 is described as being configured to execute software 18A operable to control the amount of steam supplied to the CO₂ capture system 12 depending on operating load of the boiler 22, the CO₂ pricing and/or electricity pricing, the present disclosure is not limited in this regard as the processor 16 can also be configured to analyze and control systems for removal of nitrogen oxides and sulfur oxides.

In one embodiment, the processor 16 is configured to execute software 18A operable to receive advance notice of anticipated low prices for electric power, for example when electric power prices are anticipated to be low because wind generators are expected to come onto the electric grid. The processor 16 is configured to operate the CO₂ capture system 12 at less than design efficiency to accumulate CO₂ in the CO₂ capture system 12, upon receipt of a signal 54 from the computer 20 indicative of advance notice of and before the occurrence of low electric power pricing event. The processor 16 is configured to reduce or terminate operation of the compressor 36 before the occurrence of the low electric power pricing event and to operate the compressor 36 during the low electric power pricing event. In one embodiment, the processor 16 is configured to calculate the cost associated with operation of the CO₂ capture system at a reduced efficiency, calculate the cost savings associated with compressing the CO₂ during the low electric power pricing event and determine whether or not to: 1) reduce the efficiency of the CO₂ capture system 12 before the low electric power pricing event; 2) reduce or terminate operation of the compressor 36; and 3) operate the compressor 36 during the low electric power pricing event. In one embodiment, the processor 16: 1) reduces the efficiency of the CO₂ capture system 12 before the low electric power pricing event; 2) reduces or terminate operation of the compressor 36; and 3) operates the compressor 36 during the low electric power pricing event when the increase in the cost of operating the CO₂ capture system 12 at the reduced efficiency is less than 10 percent for a 2.5 percent increase in CO₂ loading of the CO₂ capture system 12 before the low electric power pricing event.

In one embodiment, the processor 16 is configured to execute software 18A operable to determine the cost of reducing the amount of coal used to fire the boiler 22 and replacing the reduction with an energy equivalent of natural gas. The software receives input data on the amount of CO₂ generated from firing with coal and natural gas and determines if reductions in the amount of CO₂ generated when the boiler 22 is co-fired with natural gas and coal as compared to firing the boiler on coal alone would generated enough CO₂ capture cost savings to economically justify the co-firing of the boiler with coal and natural gas.

In one embodiment the processor 16 is configured to execute software 18A operable to generate signals to the electric power generation power plant 11 (e.g., the steam turbine 24 and/or the electric generator 28) to adjust output of the power plant to increases or decreases in frequency of the electric power grid. For example, the processor is configured to: 1) increase steam flow to the steam turbine 24 by throttling closed steam flow to the CO₂ capture system 12, in response to a decrease in frequency of the electric power grid; 2) decrease steam flow to the steam turbine 24 by increasing steam flow to the CO₂ capture system 12, in response to an increase in frequency of the electric power grid.

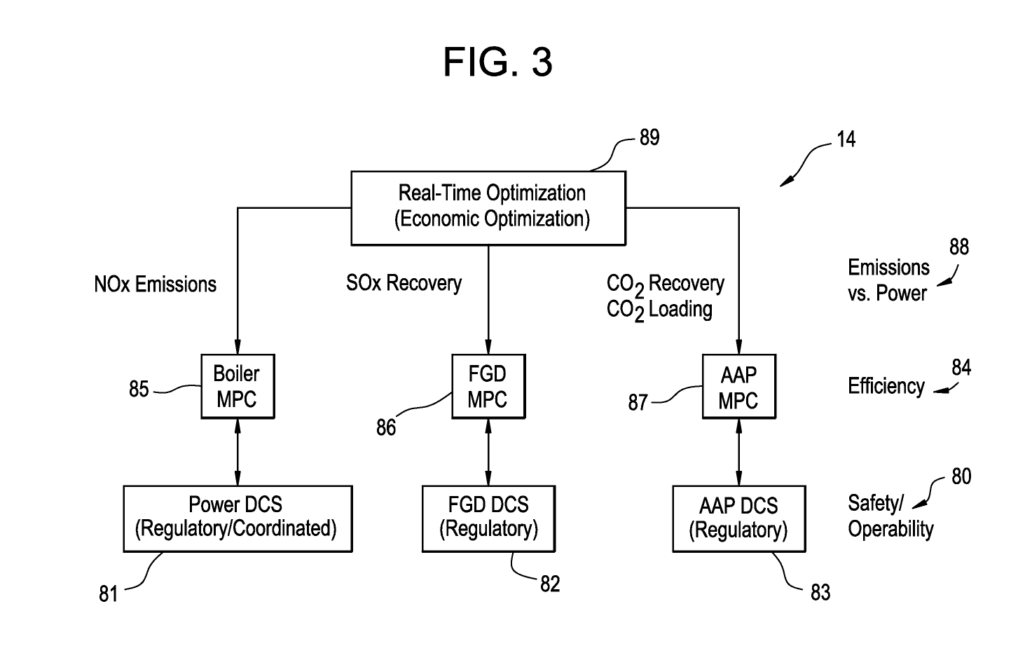

Referring to FIG. 3, the control system 14 is configured to affect Model Predictive Control (MPC) for real time optimization of the electric power generation power plant 11 and the CO₂ capture system 12. The control system 14 includes tiered software functionality including a regulatory tier 80 for controlling safety and operability of electric power generation power plant 11, a Flue Gas Desulfurization System (FGDS) and the CO₂ capture system 12 via a Distributed Control Systems (DCS), including a power DCS 81, and FGDS DCS 82 and an AAP DCS 83. The control system software also includes an efficiency tier 84 which includes a boiler MPC 85 for maximizing boiler efficiency, limiting emissions (e.g., nitrogen oxide emissions control) and minimizing steam temperature deviations, a FGDS MPC 86 for sulfur oxide control and an AAP MPC 87 for control of CO₂ capture. The control system software also includes an emissions/power tier having a MPC module 89 for real-time economic optimization (RTO) of the sale of electric power and CO₂. The MPC module 89 treats the RTO economic targets as constraints and is configured to predict the need for reductions in steam supplied to the CO₂ capture system 12 in advance of the need for such a reduction. The MPC module 89 is also configured to identify solvent loading targets and use such targets as an input to an algorithm (e.g., encoded within the software 18A) for optimizing the cost for compression of the CO₂.

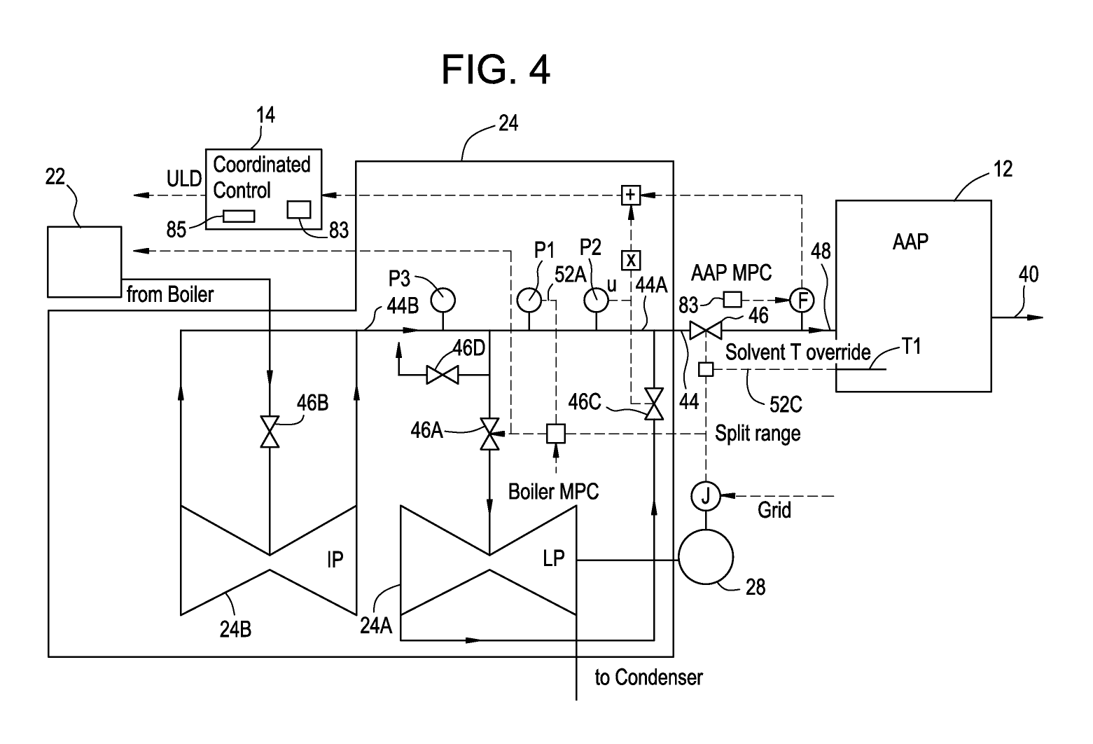

As shown in FIG. 4 the AAP DCS 83 and/or the boiler DCS controls the flow rate of steam supplied to a low pressure turbine 24A from a intermediate pressure turbine 24B by throttling the valve 46 and/or the valves 46A, 46B and/or 46C. In addition, the AAP DCS 83 is configured to simultaneously open valve 46A and throttle valves 46 and/or 46C. The steam turbine system 24 includes pressure switches P1 and P2 in a line 44A downstream of the low pressure turbine 24A. The pressure switch P1 is in communication with the valve 46A and the pressure switch P2 is in communication with the valve 46C. The pressure switches P1 and P2 transmit signals to valves 46A and 46C, respectively to throttle the valves 46A and 46C to maintain a minimum predetermined pressure in a crossover line 44B. A pressure switch P3 is in communication with the crossover line 44B to measure pressure therein. In addition, the CO₂capture system 12 includes a temperature switch T1 which is in communication with the valve 46 to limit temperature of a solvent in the CO₂ capture system 12 to below a predetermined magnitude to preclude degradation of the solvent. For example, the temperature switch T1 is configured to generate a high temperature override to throttle closed the valve 46 when temperature approaches, reaches or exceeds the predetermined value. In the event the high temperature override occurs at the same time as a high frequency or excess power event on the grid, the pressure switch P3 transmits a signal to a turbine bypass valve 46D to discharge steam to the atmosphere.

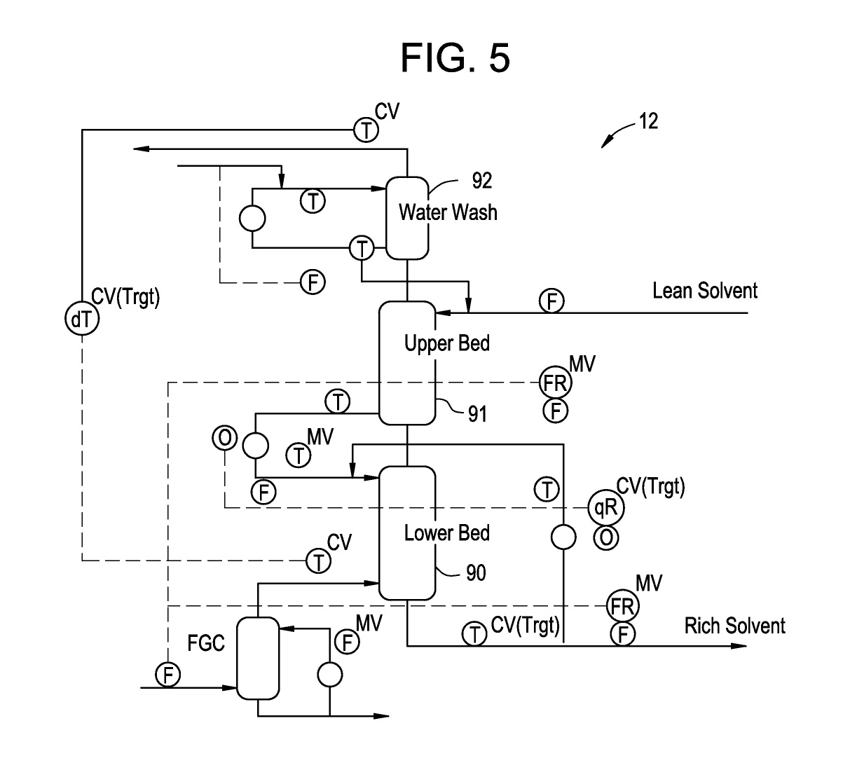

Referring to FIG. 5, in one embodiment the CO₂ capture system 12 includes a lower absorber bed 90 in communication with an upper absorber bed 91. The upper absorber bed 91 is in fluid communication with a water wash system 92.

The present disclosure includes a method for operating a power plant. The method includes providing an electric power generation plant in communication with a CO₂ capture system; providing a control system in communication with the electric power generation plant and the CO₂ capture system, the control system including a first processor and a data storage device; and providing a computer having a second processor. The method further includes generating in the second processor economic information 21A relating to real time electric power pricing and/or CO₂ capture, compression and emissions credits. The method includes a step of receiving in the first processor the economic information relating to real time electric power pricing and/or CO₂ capture, compression and emissions credits. The first processor controls the electric power generation plant and the CO₂ capture system based on the economic information relating to real time electric power pricing and/or CO₂ capture, compression and emissions credits to optimize the economics of the sale of the electric power and/or the economics of CO₂ capture, compression and emissions credits.

In one embodiment, the method includes determining when a price of CO₂ is sufficiently high to justify operation of the CO₂ capture system 12. In one embodiment, the method includes determining when a price of electric power is sufficiently higher than a price of CO₂ to justify reducing the rate of CO₂ capture in the CO₂ capture system.

A steam turbine system and an electric generator are provided in the electric power generation plant. In one embodiment the method includes transmitting signals to the steam turbine system and the electric generator to increase electric power production during a period of time when the rate of CO₂ capture in the CO₂ capture system is reduced, to increase the profit from the sale of electric power and/or CO₂.

In one embodiment, the method includes receiving by the first processor advance notice of anticipated low prices for electric power. In one embodiment, the method includes operating the CO₂ capture system at less than design efficiency to accumulate CO₂ in the CO₂ capture system, before receipt of the advance notice of anticipated low prices for electric power. In one embodiment the method includes providing a compressor in the CO₂ capture system for compressing captured CO₂. The method also includes an option to reduce operation of the compressor before the receipt of the advance notice of anticipated low prices for electric power and/or operating the compressor during a period of time when prices for electric power are low. In one embodiment, the method includes calculating costs associated with operation of the CO₂ capture system at a reduced efficiency; and calculating cost savings associated with compressing the CO₂ when electric power prices are low.

In one embodiment, the method includes operating the compressor when electric power prices are low and when an increase in cost of operating the CO₂ capture system at the reduced efficiency is less than 10 percent for a 2.5 percent increase in CO₂ loading of the CO₂ capture system before electric power prices are low.

In one embodiment, a boiler configured to be fired with coal and/or natural gas is provided in the electric power generation plant. In one embodiment, the method includes determining a cost of reducing an amount of coal used to fire the boiler; and replacing the reduction of coal with an energy equivalent of natural gas. In addition, in another embodiment the method includes adjusting output of the power plant in response to increases or decreases in frequency of the electric power grid. In another embodiment, the method includes optimizing economic operation of the electric power generation power plant and the CO₂ capture system using one of more Model Predictive Control systems.

While the present disclosure has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A power plant comprising:
an electric power generation plant in communication with a CO₂ capture system;
a control system in communication with the electric power generation plant and the CO₂ capture system, the control system including a first processor and a data storage device;
a computer having a second processor that is configured to generate and transmit at least one of economic information relating to real time electric power pricing and CO₂ capture, compression and emissions credits;
the first processor is configured to receive the at least one of the economic information relating to real time electric power pricing and CO₂ capture, compression and emissions credits; the first processor being configured to execute software operable to control the electric power generation plant and the CO₂ capture system based on the at least one of the economic information relating to real time electric power pricing and CO₂ capture, compression and emissions credits to optimize the economics of the sale of the electric power and/or the economics of CO₂ capture, compression and emissions credits.

2. The power plant of claim 1, wherein the first processor is configured to execute software to determine when a price of CO₂ is sufficiently high to justify operation of the CO₂ capture system.

3. The power plant of claim 1, wherein the first processor is configured to execute software to determine when a price of electric power is sufficiently higher than a price of CO₂ to justify reducing the rate of CO₂ capture in the CO₂ capture system.

4. The power plant of claim 1, wherein the electric power generation plant includes a steam turbine system and an electric generator; and the first processor transmits signals to the steam turbine system and the electric generator to increase electric power production during a period of time when the rate of CO₂ capture in the CO₂ capture system is reduced, to increase the profit from the sale of electric power and/or CO₂.

5. The power plant of claim 1, wherein processor is configured to execute software operable to receive advance notice of anticipated low prices for electric power.

6. The power plant of claim 5, wherein the processor is configured to operate the CO₂ capture system at less than design efficiency to accumulate CO₂ in the CO₂ capture system, before receipt of the advance notice of anticipated low prices for electric power.

7. The power plant of claim 5, wherein the CO₂ capture system includes a compressor for compressing captured CO₂ and the processor is configured to reduce or terminate operation of the compressor before the receipt of the advance notice of anticipated low prices for electric power.

8. The power plant of claim 7, wherein the processor is configured to operate the compressor during a period of time when prices for electric power are low.

9. The power plant of claim 7, wherein the processor is configured to calculate costs associated with operation of the CO₂ capture system at a reduced efficiency and calculate cost savings associated with operating the compressor to compress the CO₂ when electric power prices are low.

10. The power plant of claim 9, wherein the processor is configured to operate the compressor when electric power prices are low and when an increase in cost of operating the CO₂ capture system at the reduced efficiency is less than 10 percent for a 2.5 percent increase in CO₂ loading of the CO₂ capture system before electric power prices are low.

11. The power plant of claim 1, wherein the electric power generation plant includes a boiler configured to be fired with at least one of coal and natural gas and the processor is configured to execute software operable to determine a cost of reducing an amount of coal used to fire the boiler and replacing the reduction of coal with an energy equivalent of natural gas.

12. The power plant of claim 1, wherein the processor is configured to execute software operable to generate signals to the electric power generation power plant to adjust output of the power plant to increases or decreases in frequency of the electric power grid.

13. The power plant of claim 1, wherein the control system includes at least one Model Predictive Control (MPC) for real time optimization of the electric power generation power plant and the CO₂ capture system.

14. A method for operating a power plant comprising:
providing an electric power generation plant in communication with a CO₂ capture system;
providing a control system in communication with the electric power generation plant and the CO₂ capture system, the control system including a first processor and a data storage device;
providing a computer having a second processor;
generating in the second processor at least one of economic information relating to real time electric power pricing and CO₂ capture, compression and emissions credits;
receiving in the first processor at least one of economic information relating to real time electric power pricing and CO₂ capture, compression and emissions credits;
controlling by the first processor the electric power generation plant and the CO₂ capture system based on the at least one of the economic information relating to real time electric power pricing and CO₂ capture, compression and emissions credits to optimize the economics of the sale of the electric power and/or the economics of CO₂ capture, compression and emissions credits.

15. The method of claim 14, including the step of:
determining when a price of CO₂ is sufficiently high to justify operation of the CO₂ capture system.

16. The method of claim 14, including the step of:
determining when a price of electric power is sufficiently higher than a price of CO₂ to justify reducing the rate of CO₂ capture in the CO₂ capture system.

17. The method of claim 14, including the steps of:
providing a steam turbine system and an electric generator; and
transmitting signals to the steam turbine system and the electric generator to increase electric power production during a period of time when the rate of CO₂ capture in the CO₂ capture system is reduced, to increase the profit from the sale of electric power and/or CO₂.

18. The method of claim 14, including the step of:
receiving by the first processor advance notice of anticipated low prices for electric power.

19. The method of claim 18, including the step of:
operating the CO₂ capture system at less than design efficiency to accumulate CO₂ in the CO₂ capture system, before receipt of the advance notice of anticipated low prices for electric power.

20. The method of claim 18, including the steps of:
providing a compressor in the CO₂ capture system for compressing captured CO₂; and
reducing operation of the compressor before the receipt of the advance notice of anticipated low prices for electric power.

21. The method of claim 20, including the step of:
operating the compressor during a period of time when prices for electric power are low.

22. The method of claim 20, including the steps of:
calculating costs associated with operation of the CO₂ capture system at a reduced efficiency; and
calculating cost savings associated with compressing the CO₂ when electric power prices are low.

23. The method of claim 22, including the step of:
operating the compressor when electric power prices are low and when an increase in cost of operating the CO₂ capture system at the reduced efficiency is less than 10 percent for a 2.5 percent increase in CO₂ loading of the CO₂ capture system before electric power prices are low.

24. The method of claim 14, including the steps of:
providing a boiler configured to be fired with at least one of coal and natural gas in the electric power generation plant;
determining a cost of reducing an amount of coal used to fire the boiler; and
replacing the reduction of coal with an energy equivalent of natural gas.

25. The method of claim 14, including the step of:
adjusting output of the power plant in response to increases or decreases in frequency of the electric power grid.

26. The method of claim 14, including the step of:
optimizing economic operation of the electric power generation power plant and the CO₂ capture system using at least one Model Predictive Control system.
